(19) United States
(12) Patent Application Publication
(10) Pub. No.: US 2017/0262654 A1
(43) Pub. Date: Sep. 14, 2017

(54) SECURE GROUP DATA EXCHANGE

(71) Applicants: Rita H. Wouhaybi, Portland, OR (US); Lama Nachman, Santa Clara, CA (US); Dawn Nafus, Hillsboro, OR (US); Pete A. Denman, Portland, OR (US); Lenitra M. Durham, Beaverton, OR (US); Sangita Sharma, Portland, OR (US)

(72) Inventors: Rita H. Wouhaybi, Portland, OR (US); Lama Nachman, Santa Clara, CA (US); Dawn Nafus, Hillsboro, OR (US); Pete A. Denman, Portland, OR (US); Lenitra M. Durham, Beaverton, OR (US); Sangita Sharma, Portland, OR (US)

(21) Appl. No.: 15/069,149

(22) Filed: Mar. 14, 2016

(51) Int. Cl. G06F 21/62; G06F 17/30; G06F 21/53; H04L 29/06

(52) U.S. Cl. CPC G06F 21/6254; H04L 63/08; G06F 17/30864; G06F 21/53; G06F 2221/033

(57) ABSTRACT

System and techniques secure group data exchange are described herein. A template may be obtained from local store. The template defines data segments and operations on data segments. A data segment definition may be extracted from the template. The data segment definition including a set of demographic values. An external store may be queried for external data segments with a definition including at least one demographic value from the set of demographic values. The data segments include an owner entity. A scenario may be executed in accordance with the template using a local data segment and the external data segments to produce an experimental result. The experimental result may be communicated to the owner entity.

### TECHNICAL FIELD

Embodiments described herein generally relate to data exchange and more specifically to secure group data exchange.

### BACKGROUND

Data collection and analysis has been important to developing models of the world. The types of data collected and the types of analysis applied to data vary greatly depending on the question sought. In data collection, a variety of techniques have been employed, including questionnaires and physical property measurement among others. Fields, such as statistics have been developed to distill meaning from often noisy or contradictory data. In both cases, however, often a specific question is formulated prior to the data gathering and analysis,

Recently, technological developments have led to the widespread collection of data without direction from a particular question. Such data may include activity monitoring (e.g., via a wearable device), food consumption, mood, or communications (e.g., via a social network), health data (e.g., via electronic medical records), among others. Often this data is collected via a voluntary act by a user, however, the user wishes to keep the data private.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of a system for secure group data exchange, according to an embodiment.

FIG. 2 is a swim lane diagram of an example of a communication for secure group data exchange, according to an embodiment.

FIG. 3 illustrates an example user interface to construct a template, according to an embodiment.

FIG. 4 illustrates a flow diagram of an example of a method for secure group data exchange, according to an embodiment.

FIG. 5 illustrates a flow diagram of an example of a method for secure group data exchange, according to an embodiment.

FIG. 6 is a block diagram illustrating an example of a machine upon which one or more embodiments may be implemented.

### DETAILED DESCRIPTION

Data collection has reached a new scale with advances in mobile apps and wearables. The type and scale of this data collection could only be wished for by professionals only a few years back. Some of these data collection tools provide a way for people to look at their data and sometimes share information, such as total number of steps walked in a day for the purposing of competing with others, or a goal of losing twenty pounds to get support from others.

Some data analysis tools require users to relinquish control over their data. Many apps and online services have been architected to ensure that they are walled gardens of data. In some cases, this is done in order to protect their business models. In some instances, these systems have included application programming interfaces (APIs) to provide users with access to their data. However, observations indicate that users find these single-purpose static usages of their data do not hold user attention and participation declines. The hindrance of being able to share data in meaningful ways is in the top three reasons why a third of consumers abandon their wearable within the first six months of owning it.

A user's desire to keep their data private addresses a social concern for the user, but impairs group analysis of the data. Over the last few years, data sharing has gained a bad reputation. Users, aware or not, are being tracked and monitored by different software (cookies, plugins, tracking apps, etc.) and hardware (cameras, audio, wearables, etc.). The data is often gathered by large companies, who mine it for interesting behavior. These companies may use the outcomes for advertisements or other services that they can monetize. As a result, people may stop using these services, self-censor, attempt to erase their data, or stop caring about their privacy. This behavior creates a dilemma because data sharing can be very valuable to the user if the user can use the data to address questions or solve problems, such as locating patterns of behavior or even to promote the wellbeing of others.

Thus, what is needed is a system for secure group data exchange. The system facilitates user data sharing among individuals who might not even know of each other's existence but could benefit from leveraging each other's data based on, for example, multiple usages, goals, or patterns. The system implements anonymity procedures to address individual identification through the shared data. The system also rewards sharing by redistributing results to users who contributed data to those results. By enabling these features, the present system allows users to share patterns about their data (i.e., not necessarily raw data), which supports usages ranging from collaborating on a common problem, seeking advice, providing leanings, to recruiting participants. Additional details and embodiments are described below.

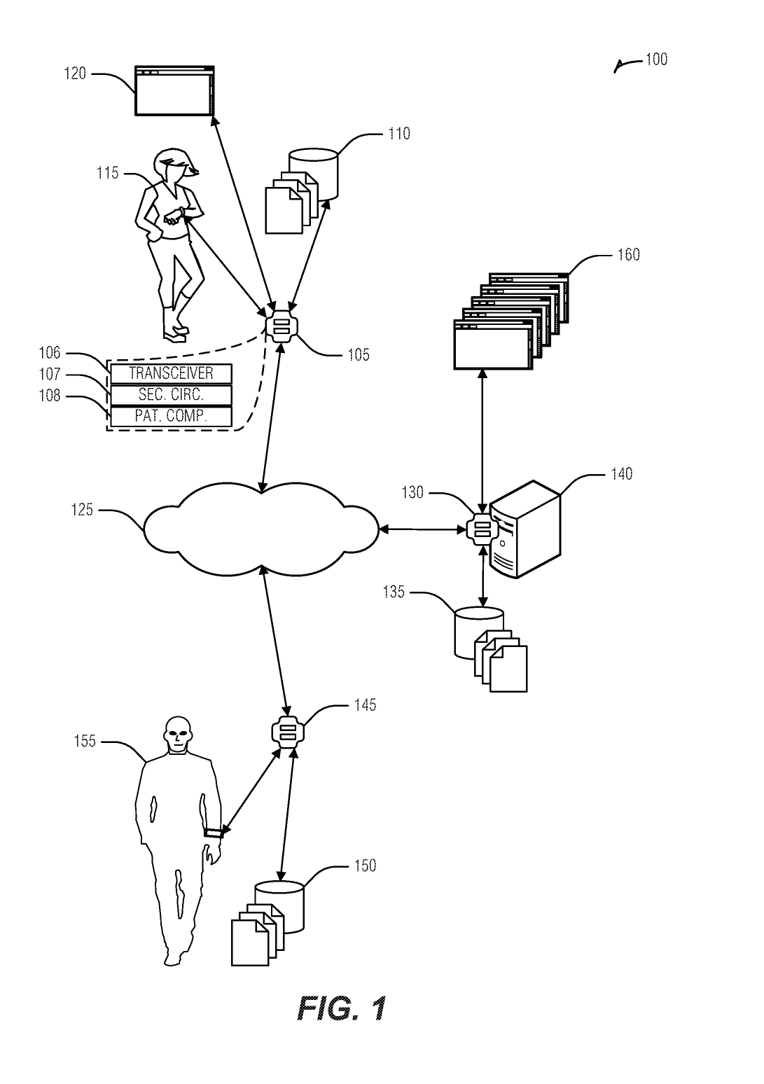

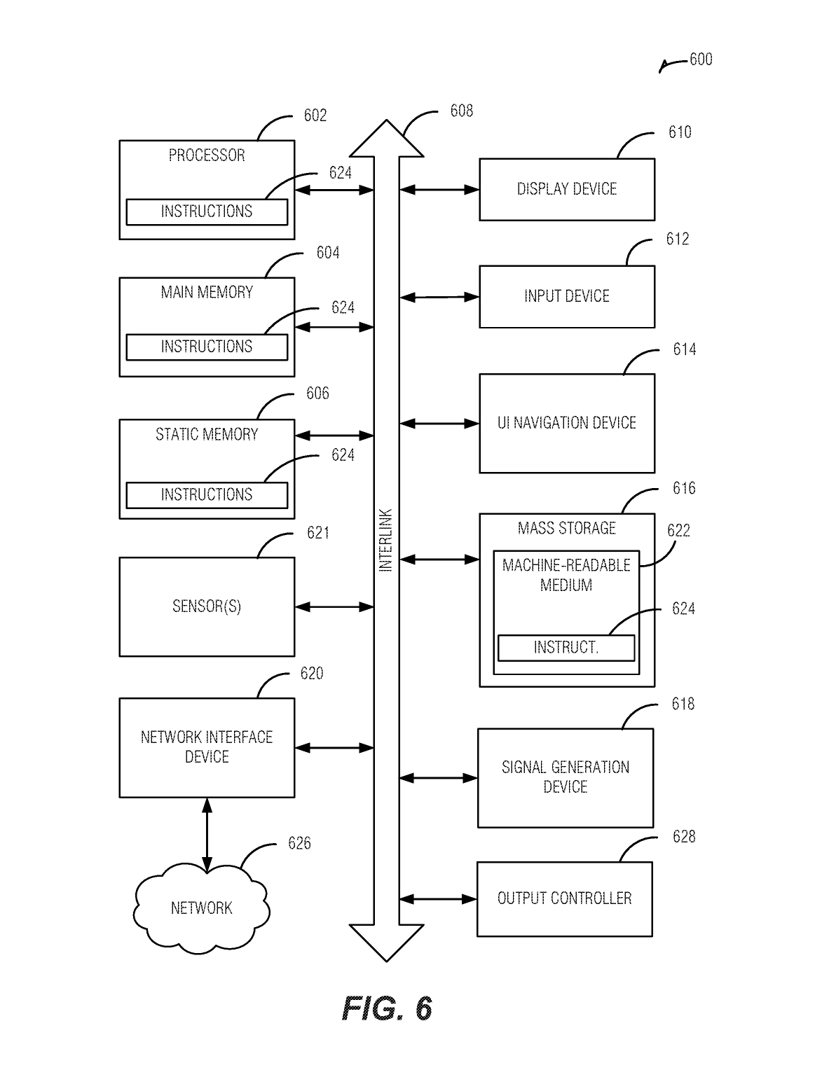

FIG. 1 is a block diagram of an example of a system 100 for secure group data exchange, according to an embodiment. The system 100 includes a variety roles, each of which has an autonomous agent (autonomous agent). For clarity, the autonomous agent 105 is referred to as a local autonomous agent and will also be referenced when autonomous agents are discussed generally, autonomous agent 130 is the aggregator autonomous agent, and autonomous agent 145 is the remote autonomous agent. Autonomous agents are implemented using computer hardware, such as that described below with respect to FIG. 6.

The autonomous agents 105, 130, and 145 are respectively coupled to data stores 110, 135, and 150 while in operation. The data stores 110, 135, and 150 maintain respective data streams and data segments that are part of the data streams. The autonomous agents 105, 130, and 135 are connected with each other via a network 125, such as the Internet, mesh networks, etc. The local autonomous agent 105 and remote autonomous agent 145 are also illustrated as being coupled to wearable devices worn by a local user 115 and remote user 155 when in operation. The aggregator autonomous agent 130 is also illustrated as coupled to server 140 which may provide interfaces to the data store 135 or other services 160. The local autonomous agent 105 is also illustrated as having an interface to a service 120.

The autonomous agent 105 includes a transceiver 106, a pattern comparator 108, and optionally security circuitry 107, all of which are implemented in computer hardware (e.g., circuitry, processors, machine readable media, etc.) as described below with respect to FIG. 6.

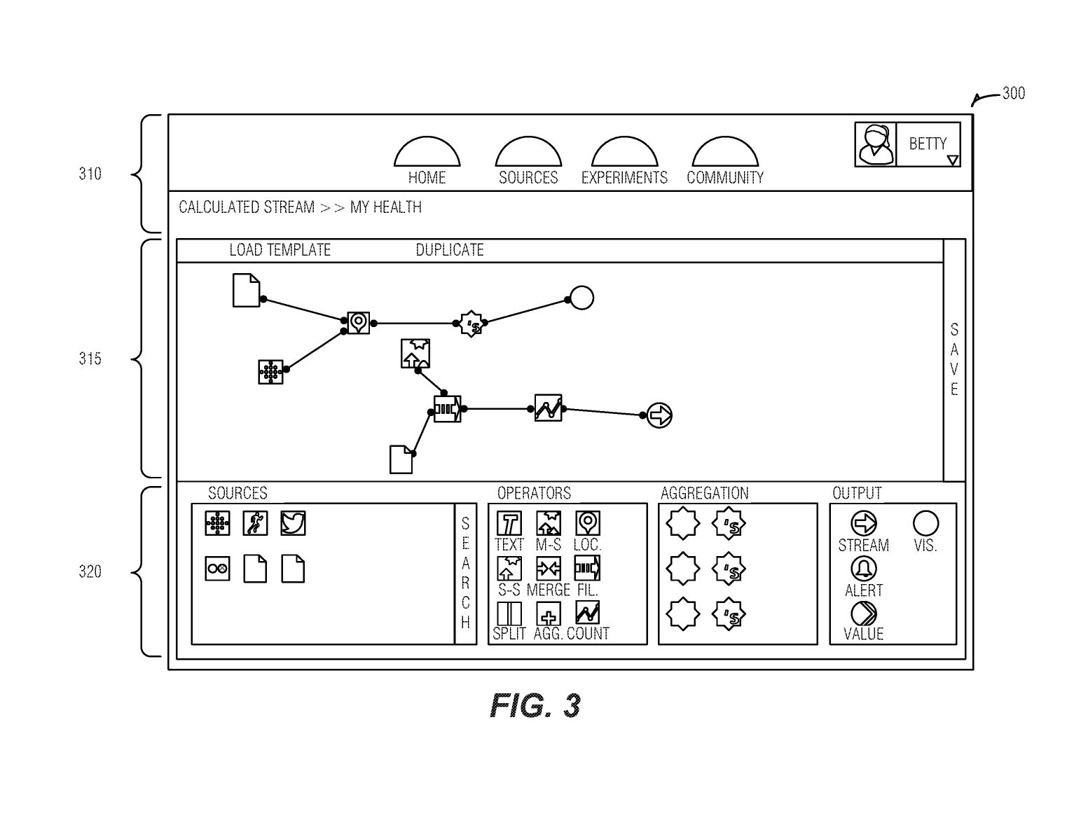

The pattern comparator 108 is built to obtain a template from the local data store 110. The template includes definitions for data segments and operations on data segments to execute a scenario. FIG. 3 below illustrates an example template manipulation user interface. In an example, a data segment is a portion of a data stream. In an example, the portion is determined by a window of time (e.g., a start time and later end time that are not the same). This example address time-series data that has a time component that is often plotted on the x-axis when visualized. It could be numerical data, such as steps taken, or can take other forms like texts tweeted, images posted, or videos commented on, among others.

The operations of the template are procedures, equations, transformations, and other data manipulations that the user selected to apply to the data segments. The operations are drawn from a palette of computations or visualizations that the user can apply to one or more of their data streams. Some operations allow users to filter (e.g., clean) their data, for example, getting rid of spikes (e.g., artifacts of a bad sensor) or filling gaps with averages, while some operations are more introspective or predictive (e.g., computing correlations, statistical measures, or time shifting).

In an example, to obtain the template, the pattern comparator 108 is built to present a user interface. An example user interface is illustrated in FIG. 3 and described below. In an example, the user interface includes a set of data streams, a set of operations and filters, a set of output providers, and an assembly area. In the assembly area a selected data stream is connected to an output provider. This combination of the data streams, filters, operations, connection, and output provider is the template. In an example, the user interface includes a set of operators. In an example, the connection includes an operator. The operator operates on the stream, transforming it into an interim value before being given to the output provider. In an example, the user interface includes a set of aggregations. In an example, the connection includes an aggregation. Again, the aggregation combines data, for example, from multiple user-streams (e.g., specific data streams of specific users) to produce another interim set of values that are passed to an output provider, another aggregation, an operator, etc.

Local user 115 data is stored, at least in part, in the local store 110. In addition, local user 115 data may be transferred to the service 120 (e.g., a vendor website for a fitness wearable) and accessible to the local autonomous agent 105 via an API. In an example, the local user 115 authorizes the server 140 to maintain an authentication set to collect user data from services 160 directly. In this example, when sharing data, the local user 115 need not waste her own bandwidth to upload the data upon each request by, for example, the remote agent 150. The authentication set may be an OAuth credential. When the local user 115 invalidates the credential, the service 140 or the agent 130 will no longer have direct access to the services 160 employed by the local user 115.

In addition to automatically accessed data, such as via an API to a service or directly from a wearable device, the local user 115 may also upload their personal files that they might have created, for example, using a spreadsheet or other editor in order to track their data (e.g., food consumed, books read, physical weight, activities, symptoms related to a health condition, etc.). These uploaded files may be maintained at one or more of the local store 110 or the aggregator store 135. In an example, whether personally maintained (e.g., in the spreadsheet) or accessed via an API, the data stream is a self-reported value. In an example, the self-reported value is at least one of a mood, consumption of material, or interpersonal interaction.

In an example, the portions of the data stream are determined by a time-value in the data stream distinguishable from other time-values in the data stream. For example, a wearable fitness device may include a pedometer and a heart-rate monitor and produce outputs for both function during a similar time window. However, for that given time window, each function may be separated in different data segments. This separation permits, for example, more refined scenario building and also allows for a finer level of granularity when applying permissions.

Permissions are configurable in a variety of ways. The system 100 includes three basic levels of permissions, private, public, and analytic. The public and private permissions operate as one would expect; private entails no sharing while public entails complete sharing. Analytic allows for data sharing given proper anonymity safeguards. For example, the pattern comparator 108 may receive a request for a data segment originating with the remote user 155. The security circuitry 107 may be built to test the request against an anonymity—and optionally a risk assessment—framework. This framework assesses a number of factors to improve the anonymity of the local user 115 without impairing the usefulness of the data. In an example, the framework may predicts the risk associated with exposing the data based on its uniqueness and settings of other users in the system for comparable streams. The security circuitry 107 will release the data segment to the remote autonomous agent 145, for example, when the request complies with the anonymity framework and deny the request otherwise. Thus, the permissions and the anonymity framework operate together to enhance secure group data exchange.

In an example, permissions may be applied to at different levels in a hierarchy. For example, permissions may be assigned at the data segment level, the data stream level, or even a provider level that may provide several (e.g., a group of) data streams. Example providers may include a device (e.g., wearable, refrigerator, etc.), a service 105, a family of services 160, or an API. Further, the permissions may be specific to a group of recipient users or individual users. For example, the local user 115 may assign analytic permissions to a group of streams (e.g., from a fitness wearable) or a specific stream (e.g., hours slept) respectively to a group of people (e.g., running club) and specific individuals (e.g., her mother) in order to reduce the cognitive load. In an example, crowd-sourcing may be employed to share practices for permission settings (e.g. people set their weather data to analytics vs mood to private).

In an example, the anonymity framework includes limiting requests to a predetermined number of queries within a given time window. For example, the remote user 155 may only make three requests for data for a given week (e.g., the last week of 2015). The number of requests may be specific to a requesting user (e.g., while the remote user 155 may only make six requests for a given day, another user may also make six requests a day), a data stream, a set of data owners (e.g., users who have opened up their data for analytic queries), or a data segment.

In an example, the anonymity framework includes a minimum number of participants to a result of which the data segment will be a part. In an example, minimum number is greater than three. These restrictions further protect the local user's anonymity by combining the data of several users. In an example, the make-up of the users who are participating may be varied from one request to another, further obfuscating any given user's identity.

In an example, anonymity framework includes a maximum frequency with which a requester (e.g., the remote user 155) can make the request. Such a frequency may be expressed and number of requests over time, such as five requests a month. This varies by the previous request/time restriction in that it is not concerned with the requested time periods, but rather limits the rate of data that the remote user 155 may pull from the local user 115. Because of the dynamic nature of most personal data, such a restriction generally allows the underlying data to change resulting in difficulties in ascertaining the local user 115 identity.

In an example, the security circuitry 107 is built to anonymize the data segment provided in response to the request. In an example, to anonymize the data segment, the security circuitry is to assign an anonymous identity, for example, to the local user 115. The anonymous identity may be maintained at either the local store 110 or the aggregator store 135, but the connection between the anonymous identity and user identity corresponding to the data segment is kept secret from the requester originating the request (e.g., the remote user 155). In an example, the anonymous identity may be used by the local user 115 to query an external store, participate in chat sessions, or other activities in the system 100.

In this requester example, the pattern comparator 108 is built to receive the results obtained using the data segment from the requester of the request. In an example, to receive the results includes the pattern comparator 108 to receive a template used to create the results. This receipt of the template may be used to allow the local user 115 to recreate the scenario, thus effectively sharing not only the original results, but also the ability for the local user 115 to examine their situation in the future. For example, the local user 115 might have access to different sets of data through group memberships or relationships with other users in the system. This would allow the local user 115 to obtain a different result when running the template than the results that were shared with that local user 115. In other cases, the system 100 may share the result based on users who shared their data with everyone rather than specifically with the initial user who created the experiment and template. This exception is added to protect the privacy of those users who did not share with everyone.

In an example, a data stream is output of a sensor measuring an aspect of the user (e.g., local user 115 or remote user 155). In an example, the sensor is at least one of a heart monitor, a glucose monitor, or an activity monitor.

The pattern comparator 108 is also built to extract a data segment definition from the template. The data segment definition includes a set of demographic values. These demographic values may be used to match the segment to a query, and may include, a time frame of available data segments, a type of data (e.g., from a wearable pedometer, from a satellite navigation system, from a particular vendor services, etc.), a user identifier (e.g., either the local user's identifier or the anonymous identifier used by the local user 115), a user physical measurement (e.g., height, weight, waist measurement, body mass index, etc.), user gender, user societal affiliations (e.g., race, relationship status, religious membership, etc.), user location, a set of user interests, a size (e.g., in bits), an encoding, among other things. This level of specificity permits varied and specific scenarios, enticing continued user participation.

The pattern comparator 108 is also built to execute a scenario in accordance with the template using a local data segment and external data segments to produce an experimental result. This experimental result is the answer to the question embodied in the template. The experimental results may be in a variety of forms, including numeric, text (e.g., an expert system explanation of the numeric results), visual (e.g., a graph, animation, etc.), among others. In an example, the experimental result may be in the form of a snapshot. A snapshot may be numerical or visual and obfuscate details of the data used to produce the snapshot. In an example, a snapshot is not editable and does not have any traces of raw data. Thus, snapshots are generally easier to share without implicating privacy concerns.

In an example, the pattern comparator 108 is built to initiate a request for an external data segment, received the external data segment in a sandboxed form, and present the external data segment in a sandbox. In this example, the sandbox prevents re-use or storage of the external data segment. This protection may be implemented in a number of ways, including cryptographic techniques associated with digital rights management. Creating sandboxed environments where users can see, access, and analyze data but cannot take copy of it is desirable, for example if a group has different sets of expertise that they use to complement each other, or in cases where multiple datasets could benefit from each other but it is unclear how the benefit may be gained without first looking at the data. Thus, a less rigorous anonymity or permission level may be applied by the user contributing the data because assurances that the data will not be later used against them are made.

The transceiver 106 includes transmission components, such as a radio or other photon based transceiver, a bus, interlink, or network infrastructure card (NIC) device to communicate with, for example, the network 125, autonomous agents 130 or 145, to wearable devices or services 120 and 160. In addition to the communications hardware, the transceiver 106 is built to query an external store (e.g., aggregator store 135 or remote store 150) on behalf of the pattern comparator 108 for the external data segments. The query uses at least one demographic value from the extracted data segment definition to search for other user's data segments that match (e.g., also include) that demographic value. In an example, all data segments include an owner entity. This owner entity is used to enforce the anonymity framework, as well as provide the experimental results to whomever donated data.

In an example, to query the external store includes the transceiver 106 to query the aggregator (e.g., aggregating entity) store 135. In an example, aggregator store 135 only includes data with a permission (e.g., security designation) allowing the aggregator autonomous agent 130 entity to share the data. In an example, the permission is public. In an example, the permission is analytic. In an example, the permission is applied to a group of data segments. In an example, the group is defined by a common production source (e.g., a service 120 or API). In an example, the common production source is a device.

The transceiver 106 is also built to communicate the experimental result to the owner entity. In an example, the template is also communicated along with the experimental result. Creating templates that define all the aspects of a scenario steps and communicating the templates with users in the system, even if they were not included in a social experiment, provides effective knowledge transfer between users. This may be beneficial as someone will be able to transfer a template from one kind of data to a different one, or gain insights into their own data that they had not previously contemplated or had the skill to achieve. For example, a user may gain insights into what kind of data someone could collect that they are not collecting or what methods are used (for example for data cleaning) that could be applicable irrespective of data types.

In an example, the transceiver 106 is built to use the experimental results to find additional users (e.g., to be connected to) via correlation of the experimental results and other results produces by other users. Users may benefit from sharing their data with users who track the similar types of data (e.g. fitness wearable and food logs) and are seeing similar correlations (e.g., sleep is affected by food eaten more than amount of exercise). In an example, the user may be provided the option to join a group of others asking similar questions (e.g., executing similar scenarios) to allow for more specific targeting of the group's desired data analysis (e.g. improving sleep quality). Thus, this matchmaking aids users in gaining insights from each other as well as their data. Again, this sharing does not need to be in the form of data segments, but can be snapshots, templates, etc. that are shared within the group.

Many of the examples discussed above may be implemented in a peer-to-peer arrangement or centrally implemented, for example, via the aggregator autonomous agent 130. In the centrally implemented system 100, data flows that are ultimately between the local user 115 and the remote user 145 may be mediated by the aggregator autonomous agent 130. In an example, the aggregator autonomous agent 130 maintains common data while the local autonomous agent 105 and remote autonomous agent 145 maintain specific data that is not part of the common data even if the users have given each access to the specific data. To use this specific data while maintaining security at the aggregator 140, a bifurcated sharing of templates and data segments may be implemented.

In this bifurcated technique, the transceiver 106 is built to receive experimental results and a corresponding template where the experimental results a derived from a groups of users' data segments. The pattern comparator 108 is built to provide a user interface to allow the user to inspect the received experimental results. In response to this inspection, the transceiver 106 collects an additional data segment from a user (e.g., the remote user 155) that is not in the group of users. The pattern comparator 108 executes the template using the data segments and the additional data segment together to create enhanced experimental results. These enhanced results are then presented to the user (e.g., local user 115).

In an example, the data segments for the group of users have a permission (e.g., privacy level) of public. In an example, the data segments for the group of users have a permission level of analytic. In an example, the additional data segment has a permission of private. In this example, however, the user (e.g., local user 115) has a predefined relationship with the providing user (e.g., the remote user 155) that permits access to the additional data segment.

The structures and technique of the system 100 for secure group data exchange provide a number of technical benefits over current systems. For example, through distributed data sharing, user use of, and continued enjoyment of, data collection increases. Further, user experience and expertise is shared, enhancing the capabilities of the users to effectively analyze the vast amounts of data that they are collecting. Adding the ability to share learnings about what devices and what modalities are useful for observing or inferring different phenomena provides an efficient extension of the devices currently employed by users. Some of these leanings are user generated while others are learned in the system and shared organically. However, although the capabilities of consumer data collection devices are enhanced through this sharing, user privacy is protected via the anonymity framework and granular data segment permissions. Thus, users experience the enhanced benefit of sharing while reducing the present risks.

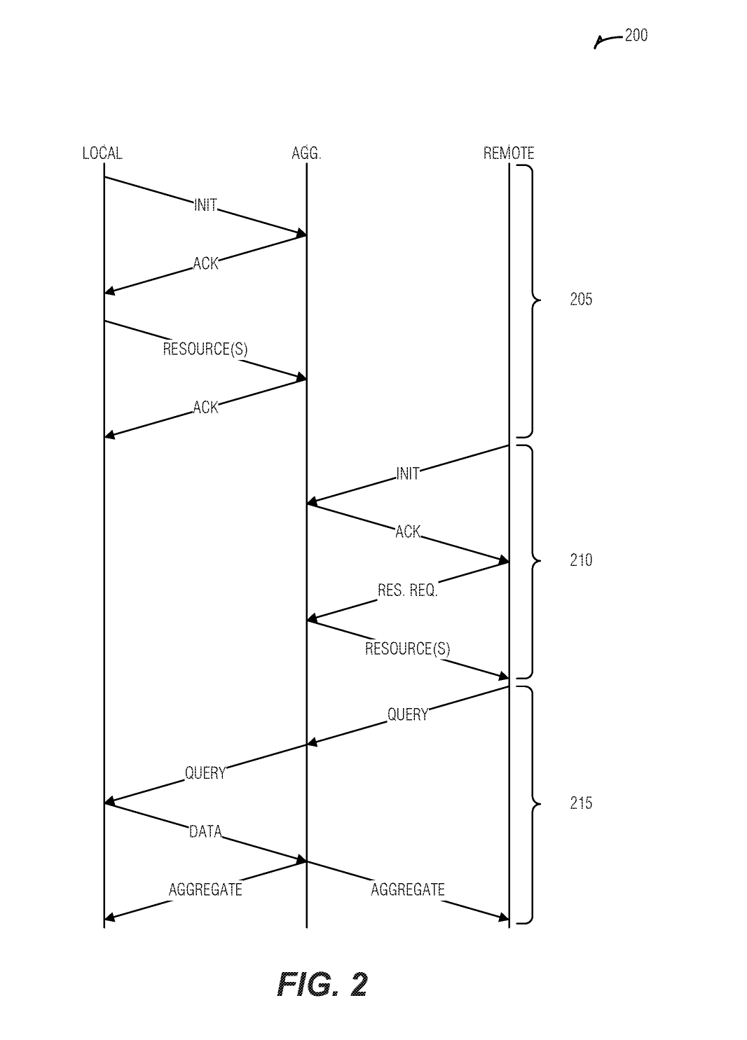

FIG. 2 is a swim lane diagram of an example of a communication 200 for secure group data exchange, according to an embodiment. In the exchange 205, the local agent (e.g., representing a user) initiates a connection to the aggregator. The aggregator acknowledges the initiation. In an example, the aggregator asks the local agent for a listing of available resources (e.g., data segments, data streams, etc.). In an example, the local agent responds to the acknowledgment, whether automatically or in response to the request for the available resources, with a resource set. In an example, the resource set is limited to those resources that are marked as public or analytics, but not private. The aggregator acknowledges receipt of the resource set from the local agent.

In exchange 210, a remote agent (at least remote to the local agent) performs an initiation procedure that is acknowledged by the aggregator. The remote agent then makes a resource request (e.g., an external store request). The aggregator filters the resource set to comply with privacy or anonymity safeguards and returns the filtered resource set listing to the remote agent. The listing may include a type of data stream, a catalog of data segments, anonymous identities for users, demographics of users that have contributed data segments, or a location in which data streams or data segments may be retrieved.

The remote agent, after having received the resource set listing, may query an external store for actual data segments or streams. In the illustrated example, the aggregator mediates the query between the remote and local agents. In addition to retrieving the data from the local agent, the aggregator may also perform an aggregation on the data. In an example, the aggregation is specified by the remote agent in the query. The results of the aggregation, or other experimental results, are communicated to both the remoted agent, fulfilling the query, and to the local agent in accordance with the local agent's data sharing. This mediated data exchange securely shares data among users in a useful way and also minimizes privacy concerns. The agents provide an effective and efficient mechanism by which to collect, categorize, and communicate the data whose volume precludes users from managing the data themselves.

FIG. 3 illustrates an example user interface 300 to construct a template, according to an embodiment. In a variety of examples discussed throughout, the user is presented with a graphical user interface (e.g., UI 300) that helps them create a scenario (e.g., social experiment). As illustrated the UI 300 illustrates an example of a “calculated experiment” and is one of visualization tools a user could use to start or access a scenario, template, or experimental results.

The UI 300 includes three regions, a navigation region 310, an assembly area 315, and a palette 320. The palette 320 is further subdivided into a sources, operators, aggregations, and outputs. In an example, any of the palette icons may be placed (e.g., via dragging, cutting and pasting, etc.) into the assembly area 315. The user may draw connections between the icons of the assembly area to construct a scenario. Generally, sources will be root nodes and outputs are leaf nodes with operators and aggregations being other (e.g., internal) nodes in the directed graph that represents the scenario.

As illustrated, the sources may include files, such as a personal log of exercise, mood, money spent, food consumed, parties held, etc., a social network input (e.g., for likes or dislikes tabulation), a fitness device's output, or another services processed data. In an example, the sources are time-valued data. The operators may include such operations as a text operation (e.g., regular expression matching, replacement, etc.), multi-stream operators (e.g., greater-than, less-than, equality, comparison between streams, etc.), location (e.g., to filter stream data by location, etc.), single-stream operators (e.g., like multi-stream operators with a constant to be compared to the stream, etc.), merge, split, aggregation (e.g., count, sum, average, etc.), or filter (e.g., to remove noise, etc.) The aggregations may include a variety of aggregations operating on both single streams and multi-streams. These aggregations represent a number of advanced statistical analysis applied to the streams. Additionally, the outputs may include a stream out (e.g., a formatted data stream as output that may be consumed by another application), visualization (e.g., a graph, animation, model, etc.), an alert (e.g., a visual or audible alarm), or a value out.

The assembly area 315 represents the elements of a template. It may include UI elements to load a template (e.g., for execution, modification, etc.), to supplicate a template, or to save the current template. In an example, when results are shared with the user, the template that produced those results is also shared and loaded into the assembly area so that the user may execute the scenario.

The navigation region 310 illustrates several macro areas of the UI 300, include a sources frame that allows the user to add, delete, and assign permissions to various personal sources of data. The experiments frame is the one illustrated in FIG. 3. The community frame provides a social networking interface where the user manages trust, groups of users, etc. In an example, the community frame allows the user to create an anonymous identity to interact with other users.

In this example the user can select multiple inputs from the bin on the bottom left side, they can then apply multiple equations, filters, and transformations. The user is able to run this on their own data and then switch to social in order to compare their results to others. Unlike professional experiments where it is often impossible to get insights into any results obtained from your data once you give a researcher access to it, the present system allows users to share the results back with all contributing users and the template (with the detailed process) on how it was generated. This system provides a snowball effect where others will jump in and modify the experiment, who will share this new result with users, as well. In this way, the expertise, and interests of these people become cumulative, breaking the silos, even if the users never meet in person.

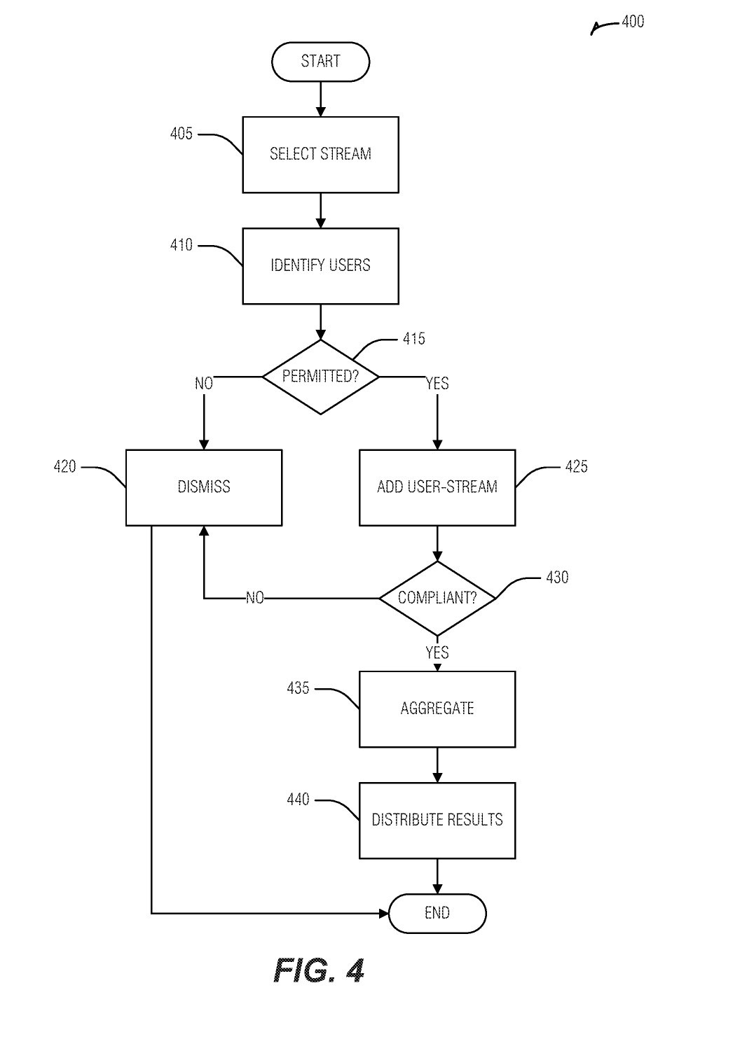

FIG. 4 illustrates a flow diagram of an example of a method 400 for secure group data exchange, according to an embodiment. The operations of the method 400 are implemented in computer hardware, such as that described above or below (e.g., circuitry).

The operations of the method 400 work to create a way for users to control what gets shared (e.g., data, processes, or snapshots) and to what extent that data is shared. To facilitate this goal, three levels of privacy are implement: private, analytic, and public. As noted above, the private and public levels operate in a traditional manner, either sharing or not-sharing data respectively. The analytic level applies to numeric data. It indicates that the user is open to have processes created by others run on their data as long as the results are aggregated with those of other users. Users may be inclined to grant analytic permission so that others in the system may find interesting patterns in the user's data, and point out how the user compares to the rest of the users. This may be useful information even if the user was ultimately unable to or uninterested in making decisions about which data processes to use. Conversely, when people see what others have done to their data, those people may have an incentive to learn about how data processes work. In this way, a positive spiral for learning and engaging with data is started and encouraged. FIG. 2 illustrates an example of aggregated social computation.

At operation 405, a data stream (or segment) is selected. As noted above, this stream may include such things as fitness data, all data from a fitness device, calories consumes, or anything else that the user wants to use for a scenario.

At operation 410, users are selected to participate in a scenario. In an example, users may be connected to the user, for example, via a social network, correlation of previous scenarios, or other demographic values. Correlation of previous scenarios may occur when, for example, two users run similar scenarios (e.g., calories consumed via a diet tracking application and calories consumed via a fitness wearable), and thus may presume to be interested in a similar question. Connecting these users may expose other interests or compatibilities that otherwise may have been overlooked.

At decision 415, ascertain whether the data stream is a permitted stream for the user running the scenario. Thus, is the data stream for a selected user public or analytic, or does the user have private (or other) access to the data stream? If the data is permitted, the user-stream is added to a candidate set (operation 425), otherwise the user-stream is dismissed (operation 420) and additional user-streams are checked for inclusion.

At operation 420, a dismissed user-stream is omitted from participating in a scenario. For example, the user-stream is deleted from the local user device.

At operation 425, permitted user-streams are added to a candidate set. The candidate set will be the base data that will be transformed via the analytics when the scenario is run.

At decision 430, after the candidate set is known, anonymity compliance is tested. Anonymity compliance addresses issues whereby the user has access to the user-stream under an understanding that the owner of the user-stream will remain anonymous (e.g., meeting the analytic permission goal) but the user manipulates the process to determine the owner. For example, the user may only request a single user data-stream meant to identify a person, such as location data over the same period (e.g., working hours) every day for a week. To address this, the anonymity compliance tests the makeup of the candidate set to address these issues. For example, the user may be limited to including three or more different owners (e.g., user-streams from three or more owner). In another example, the user may be limited to the type or frequency of requests (e.g., no more than once a day, week, month, year, etc.). In another example, the user may be limited to a total number of requests for a given time period. All of these techniques introduce variability that makes it much more difficult to identify a single owner of a user-stream while still enabling our user to effectively use many people's data.

At operation 435, The candidate set is processed in a scenario. The scenario includes a set of data (the candidate set) and operators. The operators transform (e.g., aggregate) the data to produce a result. In an example, the scenario includes visualizations, suggestions, or other non-numeric output embodying the result. These outputs may be part of a scenario template that is run to produce the results.

At operation 440, the results are shared among the owners of the user-streams that participated in the scenario. As noted throughout, returning the results may induce others to share their data. Further, users may generally receive greater benefit from the system due to the collective creativity producing results that a given user may find useful but not have previously conceptualized.

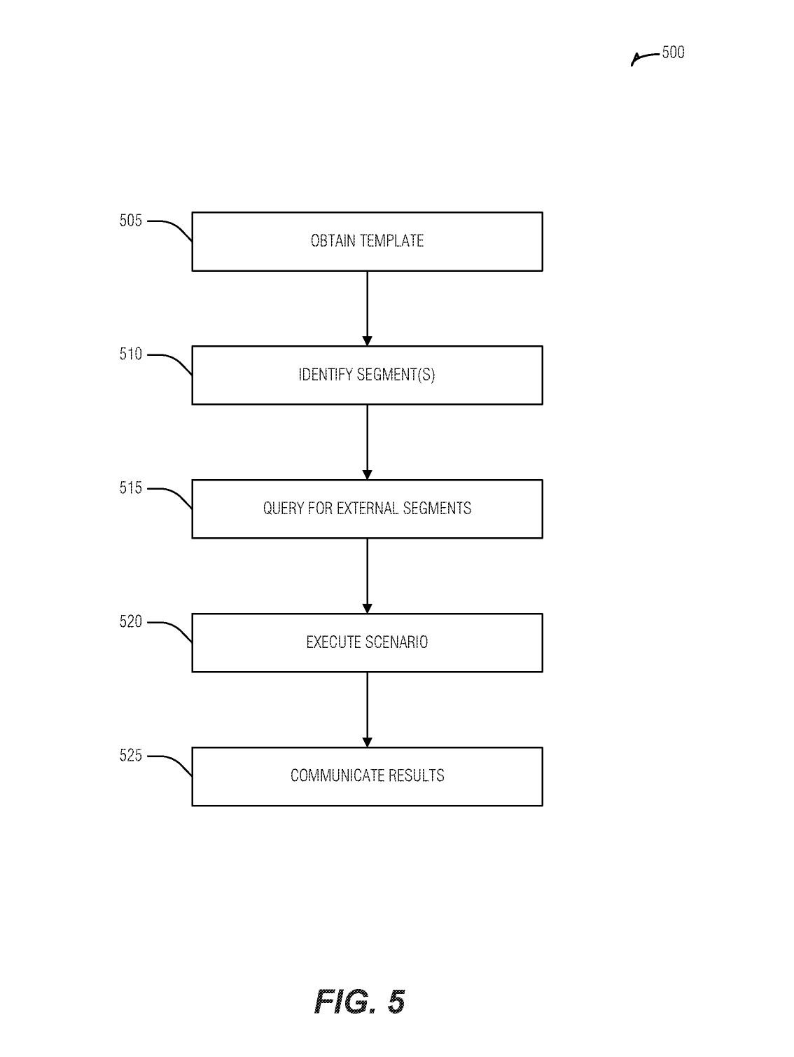

FIG. 5 illustrates a flow diagram of an example of a method 500 for secure group data exchange, according to an embodiment. Operations of the method 500 are implemented in computer hardware, such as that described above or below (e.g., circuitry).

At operation 505, a template is obtained from local store. The template defines data segments and operations on data segments. In an example, to obtain the template, a user interface is presented. In an example, the user interface includes at least one of a set of data of data streams, a set of output providers, and an assembly area where a data stream is connected to an output provider. In an example, the combination of a data stream, a connection, and an output provider is a template. In an example, the user interface includes a set of operators. In an example, the connection includes an operator. In an example, the user interface includes a set of aggregations. In an example, the connection includes an aggregation.

In an example, the data segments are portions of a data stream. In an example, the portions of the data stream are determined by a window of time. In an example, the portions of the data stream are determined by a time-value in the data stream distinguishable from other time-values in the data stream.

In an example, the data stream is output of a sensor measuring an aspect of a user. In an example, In an example, the sensor is at least one of a heart monitor, a glucose monitor, or an activity monitor. In an example, the data stream is a self-reported value. In an example, the self-reported value is at least one of a mood, consumption of material (e.g., food, calories, paper, etc.), or interpersonal interaction (e.g., verbal or written communications, “likes,” etc.).

At operation 510, a data segment definition is identified (e.g., extracted) from the template. In an example, the data segment definition includes a set of demographic values.

At operation 515, an external store is queried for external data segments with a definition including at least one demographic value from the set of demographic values. In an example, the external data segments include an owner entity. In an example, to query the external store includes querying an aggregating entity store. Here, the aggregating entity stores data with a security designation allowing the aggregating entity to share the data. In an example, the security designation is public. In an example, the security designation is analytic. In an example, wherein the security designation is applied to a group of data segments. In an example, the group of data segments is defined by a common production source (e.g., service, vendor, organization, etc.). In an example, the common production source is a device.

At operation 520, a scenario is executed in accordance with the template using a local data segment and the external data segments to produce an experimental result. In an example, the experimental result is presented to the user in the form of a visualization. In an example, the experimental result is compared to the results of other users, the comparison presented to the user, for example, via a user interface.

At operation 525, communicate the experimental result to the owner entity. In an example, the communication includes a visual. In an example, the visual is a time-value plot.

The method 500 may optionally include additional operations for receiving a request. The request operations include receiving a request from a second party for a data segment. The request is then tested against an anonymity framework. The request operations continue by providing the data segment when the request complies with the anonymity framework and not-providing the data segment otherwise.

In an example, the anonymity framework includes limiting requests to a predetermined number within a predetermined time window. In an example, the anonymity framework includes a minimum number of participants to a result of which the data segment will be a part. In an example, the minimum number is greater than three. In an example, the anonymity framework includes a maximum frequency with which a requester can make the request.

In an example, providing the data segment, in the request operations, includes anonymizing the data segment. In an example, anonymizing the data segment includes assigning an anonymous identity. Here the connection between the anonymous identity and user identity corresponding to the data segment is kept secret from a requester originating the request. In an example, the anonymous identity is used by a user to query the external store for the external data segments.

The request operations may optionally include receiving the results obtained using the data segment from a requester of the request. In an example, receiving the results includes receiving a second template used to create the results.

The operations of the method 500 may optionally include sandbox operations. The sandbox operations include requesting an external data segment from an external user. The sandbox operations may continue by receiving the external data segment in a sandboxed form. The sandbox operations may continue by presenting the external data segment in a sandbox, the sandbox preventing re-use or storage of the external data segment.

The method 500 may be optionally extended to include modified aggregation request operations. The modified aggregation request operations may include receiving second experimental results and a corresponding template. Here, the second experimental results are composed of data segments from a group of users. The modified aggregation request operations may continue by providing a user interface to allow a user to inspect the second experimental results. The modified aggregation request operations may continue by collecting, in response to the user inspecting the second experimental results, an additional data segment from a user that is not in the group of users. The modified aggregation request operations may continue by executing the corresponding template with the data segments from the group of users or the second experimental results and the additional data segment to create enhanced second experimental results. The modified aggregation request operations may continue by presenting, via the user interface, the enhanced second experimental results.

In an example, the data segments for the group of users in the modified aggregation request operations have a privacy level of at least public or analytic. In an example, the additional data segment has a privacy level of private and a recipient of the second experimental results has a predefined relationship with the user that is not in the group of users, the predefined relationship permitting access to private data.

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, engines, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

### Additional Notes & Examples

Example 1 is a system for group data exchange, the system comprising: a pattern comparator to: obtain template from local store, the template defining data segments and operations on data segments; extract a data segment definition from the template, the data segment definition including a set of demographic values; and execute a scenario in accordance with the template using a local data segment and external data segments to produce an experimental result; and a transceiver to: query an external store for the external data segments with a definition including at least one demographic value from the set of demographic values, the external data segments including an owner entity; and communicate the experimental result to the owner entity.

In Example 2, the subject matter of Example 1 optionally includes wherein to query the external store includes the transceiver to query an aggregating entity store, the aggregation entity store only includes data with a security designation allowing the aggregating entity to share the data.

In Example 3, the subject matter of Example 2 optionally includes wherein the security designation is public.

In Example 4, the subject matter of any one or more of Examples 2-3 optionally include wherein the security designation is analytic.

In Example 5, the subject matter of any one or more of Examples 2-4 optionally include wherein the security designation is applied to a group of data segments.

In Example 6, the subject matter of Example 5 optionally includes wherein the group of data segments is defined by a common production source.

In Example 7, the subject matter of Example 6 optionally includes wherein the common production source is a device.

In Example 8, the subject matter of any one or more of Examples 1-7 optionally include wherein to obtain the template includes the pattern comparator to present a user interface, the user interface including: a set of data of data streams; a set of output providers; and an assembly area where a data stream is connected to an output provider, the combination of the data stream, the connection, and the output provider being a template.

In Example 9, the subject matter of Example 8 optionally includes wherein the user interface includes a set of operators, and wherein the connection includes an operator.

In Example 10, the subject matter of any one or more of Examples 8-9 optionally include wherein the user interface includes a set of aggregations, and wherein the connection includes an aggregation.

In Example 11, the subject matter of any one or more of Examples 1-10 optionally include wherein the data segments are portions of a data stream.

In Example 12, the subject matter of Example 11 optionally includes wherein the portions are determined by a window of time.

In Example 13, the subject matter of any one or more of Examples 11-12 optionally include wherein the portions are determined by a time-value in the data stream distinguishable from other time-values in the data stream.

In Example 14, the subject matter of any one or more of Examples 11-13 optionally include wherein a data stream is output of a sensor measuring an aspect of a user.

In Example 15, the subject matter of Example 14 optionally includes wherein the sensor is at least one of a heart monitor, a glucose monitor, or an activity monitor.

In Example 16, the subject matter of any one or more of Examples 11-15 optionally include wherein the data stream is a self-reported value.

In Example 17, the subject matter of Example 16 optionally includes wherein the self-reported value is at least one of a mood, consumption of material, or interpersonal interaction.

In Example 18, the subject matter of any one or more of Examples 1-17 optionally include security circuitry to: test, in response to the pattern comparator receiving a request from a second party for a data segment, the request against an anonymity framework; and providing the data segment when the request complies with the anonymity framework and not-providing the data segment otherwise.

In Example 19, the subject matter of Example 18 optionally includes wherein the anonymity framework includes limiting requests to a predetermined number within a predetermined time window.

In Example 20, the subject matter of any one or more of Examples 18-19 optionally include wherein the anonymity framework includes a minimum number of participants to a result of which the data segment will be a part.

In Example 21, the subject matter of Example 20 optionally includes wherein the minimum number is greater than three.

In Example 22, the subject matter of any one or more of Examples 18-21 optionally include wherein the anonymity framework includes a maximum frequency with which a requester can make the request.

In Example 23, the subject matter of any one or more of Examples 18-22 optionally include wherein to provide the data segment includes the security circuitry to anonymize the data segment.

In Example 24, the subject matter of Example 23 optionally includes wherein to anonymize the data segment includes the security circuitry to assign an anonymous identity, the connection between the anonymous identity and user identity corresponding to the data segment kept secret from a requester originating the request.

In Example 25, the subject matter of Example 24 optionally includes wherein the anonymous identity is used by a user to query the external store for the external data segments.

In Example 26, the subject matter of any one or more of Examples 18-25 optionally include wherein the pattern comparator is to receive the results obtained using the data segment from a requester of the request.

In Example 27, the subject matter of Example 26 optionally includes wherein to receive the results includes the pattern comparator to receive a second template used to create the results.

In Example 28, the subject matter of any one or more of Examples 1-27 optionally include wherein the transceiver is to use the experimental results to find additional users via correlation of the experimental results and other results produced by other users.

In Example 29, the subject matter of any one or more of Examples 1-28 optionally include wherein the pattern comparator is to: request an external data segment from an external user; receive the external data segment in a sandboxed form; and present the external data segment in a sandbox, the sandbox preventing re-use or storage of the external data segment.

In Example 30, the subject matter of any one or more of Examples 1-29 optionally include wherein: the transceiver is to: receive second experimental results and a corresponding template, the second experimental results composed of data segments from a group of users; and collect, in response to a user inspecting the second experimental results, an additional data segment from a user that is not in the group of users; and the pattern comparator is to: provide a user interface to allow the user to inspect the second experimental results; execute the corresponding template with the data segments from the group of users or the second experimental results and the additional data segment to create enhanced second experimental results; and present, via the user interface, the enhanced second experimental results.

In Example 31, the subject matter of Example 30 optionally includes wherein the data segments for the group of users have a privacy level of at least public or analytic.

In Example 32, the subject matter of any one or more of Examples 30-31 optionally include wherein the additional data segment has a privacy level of private and a recipient of the second experimental results has a predefined relationship with the user that is not in the group of users, the predefined relationship permitting access to private data.

Example 33 is a method for group data exchange, the method comprising: obtain template from local store, the template defining data segments and operations on data segments; extract a data segment definition from the template, the data segment definition including a set of demographic values; query an external store for external data segments with a definition including at least one demographic value from the set of demographic values, the external data segments including an owner entity; execute a scenario in accordance with the template using a local data segment and the external data segments to produce an experimental result; and communicate the experimental result to the owner entity.

In Example 34, the subject matter of Example 33 optionally includes wherein to query the external store includes querying an aggregating entity store, the aggregation entity store only includes data with a security designation allowing the aggregating entity to share the data.

In Example 35, the subject matter of Example 34 optionally includes wherein the security designation is public.

In Example 36, the subject matter of any one or more of Examples 34-35 optionally include wherein the security designation is analytic.

In Example 37, the subject matter of any one or more of Examples 34-36 optionally include wherein the security designation is applied to a group of data segments.

In Example 38, the subject matter of Example 37 optionally includes wherein the group of data segments is defined by a common production source.

In Example 39, the subject matter of Example 38 optionally includes wherein the common production source is a device.

In Example 40, the subject matter of any one or more of Examples 33-39 optionally include wherein to obtain the template includes presenting a user interface, the user interface including: a set of data of data streams; a set of output providers; and an assembly area where a data stream is connected to an output provider, the combination of the data stream, the connection, and the output provider being a template.

In Example 41, the subject matter of Example 40 optionally includes wherein the user interface includes a set of operators, and wherein the connection includes an operator.

In Example 42, the subject matter of any one or more of Examples 40-41 optionally include wherein the user interface includes a set of aggregations, and wherein the connection includes an aggregation.

In Example 43, the subject matter of any one or more of Examples 33-42 optionally include wherein the data segments are portions of a data stream.

In Example 44, the subject matter of Example 43 optionally includes wherein the portions are determined by a window of time.

In Example 45, the subject matter of any one or more of Examples 43-44 optionally include wherein the portions are determined by a time-value in the data stream distinguishable from other time-values in the data stream.

In Example 46, the subject matter of any one or more of Examples 43-45 optionally include wherein a data stream is output of a sensor measuring an aspect of a user.

In Example 47, the subject matter of Example 46 optionally includes wherein the sensor is at least one of a heart monitor, a glucose monitor, or an activity monitor.

In Example 48, the subject matter of any one or more of Examples 43-47 optionally include wherein the data stream is a self-reported value.

In Example 49, the subject matter of Example 48 optionally includes wherein the self-reported value is at least one of a mood, consumption of material, or interpersonal interaction.

In Example 50, the subject matter of any one or more of Examples 33-49 optionally include receiving a request from a second party for a data segment; testing the request against an anonymity framework; and providing the data segment when the request complies with the anonymity framework and not-providing the data segment otherwise.

In Example 51, the subject matter of Example 50 optionally includes wherein the anonymity framework includes limiting requests to a predetermined number within a predetermined time window.

In Example 52, the subject matter of any one or more of Examples 50-51 optionally include wherein the anonymity framework includes a minimum number of participants to a result of which the data segment will be a part.

In Example 53, the subject matter of Example 52 optionally includes wherein the minimum number is greater than three.

In Example 54, the subject matter of any one or more of Examples 50-53 optionally include wherein the anonymity framework includes a maximum frequency with which a requester can make the request.

In Example 55, the subject matter of any one or more of Examples 50-54 optionally include wherein providing the data segment includes anonymizing the data segment.

In Example 56, the subject matter of Example 55 optionally includes wherein anonymizing the data segment includes assigning an anonymous identity, the connection between the anonymous identity and user identity corresponding to the data segment kept secret from a requester originating the request.

In Example 57, the subject matter of Example 56 optionally includes wherein the anonymous identity is used by a user to query the external store for the external data segments.

In Example 58, the subject matter of any one or more of Examples 50-57 optionally include receiving the results obtained using the data segment from a requester of the request.

In Example 59, the subject matter of Example 58 optionally includes wherein receiving the results includes receiving a second template used to create the results.

In Example 60, the subject matter of any one or more of Examples 33-59 optionally include using the experimental results to find additional users via correlation of the experimental results and other results produced by other users.

In Example 61, the subject matter of any one or more of Examples 33-60 optionally include requesting an external data segment from an external user; receiving the external data segment in a sandboxed form; and presenting the external data segment in a sandbox, the sandbox preventing re-use or storage of the external data segment.

In Example 62, the subject matter of any one or more of Examples 33-61 optionally include receiving second experimental results and a corresponding template, the second experimental results composed of data segments from a group of users; providing a user interface to allow a user to inspect the second experimental results; collecting, in response to the user inspecting the second experimental results, an additional data segment from a user that is not in the group of users; executing the corresponding template with the data segments from the group of users or the second experimental results and the additional data segment to create enhanced second experimental results; and presenting, via the user interface, the enhanced second experimental results.

In Example 63, the subject matter of Example 62 optionally includes wherein the data segments for the group of users have a privacy level of at least public or analytic.

In Example 64, the subject matter of any one or more of Examples 62-63 optionally include wherein the additional data segment has a privacy level of private and a recipient of the second experimental results has a predefined relationship with the user that is not in the group of users, the predefined relationship permitting access to private data.

Example 65 is a system comprising means to perform any of methods 33-64.

Example 66 is at least one machine readable medium including instructions that, when executed by a machine, cause the machine to perform any of methods 33-64.

Example 67 is at least one machine readable medium including instructions for group data exchange, the instructions, when executed by a machine, cause the machine to perform operations comprising: obtain template from local store, the template defining data segments and operations on data segments; extract a data segment definition from the template, the data segment definition including a set of demographic values; query external store for external data segments with a definition including at least one demographic value from the set of demographic values, the data segments including an owner entity; execute a scenario in accordance with the template using a local data segment and the external data segments to produce an experimental result; and communicate the experimental result to the owner entity.

In Example 68, the subject matter of Example 67 optionally includes wherein to query the external store includes querying an aggregating entity store, the aggregating entity store only includes data with a security designation allowing the aggregating entity to share the data.

In Example 69, the subject matter of Example 68 optionally includes wherein the security designation is public.

In Example 70, the subject matter of any one or more of Examples 68-69 optionally include wherein the security designation is analytic.

In Example 71, the subject matter of any one or more of Examples 68-70 optionally include wherein the security designation is applied to a group of data segments.

In Example 72, the subject matter of Example 71 optionally includes wherein the group of data segments is defined by a common production source.

In Example 73, the subject matter of Example 72 optionally includes wherein the common production source is a device.

In Example 74, the subject matter of any one or more of Examples 67-73 optionally include wherein to obtain the template includes presenting a user interface, the user interface including: a set of data of data streams; a set of output providers; and an assembly area where a data stream is connected to an output provider, the combination of the data stream, the connection, and the output provider being a template.

In Example 75, the subject matter of Example 74 optionally includes wherein the user interface includes a set of operators, and wherein the connection includes an operator.

In Example 76, the subject matter of any one or more of Examples 74-75 optionally include wherein the user interface includes a set of aggregations, and wherein the connection includes an aggregation.

In Example 77, the subject matter of any one or more of Examples 67-76 optionally include wherein the data segments are portions of a data stream.

In Example 78, the subject matter of Example 77 optionally includes wherein the portions are determined by a window of time.

In Example 79, the subject matter of any one or more of Examples 77-78 optionally include wherein the portions are determined by a time-value in the data stream distinguishable from other time-values in the data stream.

In Example 80, the subject matter of any one or more of Examples 77-79 optionally include wherein a data stream is output of a sensor measuring an aspect of a user.

In Example 81, the subject matter of Example 80 optionally includes wherein the sensor is at least one of a heart monitor, a glucose monitor, or an activity monitor.

In Example 82, the subject matter of any one or more of Examples 77-81 optionally include wherein the data stream is a self-reported value.

In Example 83, the subject matter of Example 82 optionally includes wherein the self-reported value is at least one of a mood, consumption of material, or interpersonal interaction.

In Example 84, the subject matter of any one or more of Examples 67-83 optionally include wherein the operations comprise: receiving a request from a second party for a data segment; testing the request against an anonymity framework; and providing the data segment when the request complies with the anonymity framework and not-providing the data segment otherwise.

In Example 85, the subject matter of Example 84 optionally includes wherein the anonymity framework includes limiting requests to a predetermined number within a predetermined time window.

In Example 86, the subject matter of any one or more of Examples 84-85 optionally include wherein the anonymity framework includes a minimum number of participants to a result of which the data segment will be a part.

In Example 87, the subject matter of Example 86 optionally includes wherein the minimum number is greater than three.

In Example 88, the subject matter of any one or more of Examples 84-87 optionally include wherein the anonymity framework includes a maximum frequency with which a requester can make the request.

In Example 89, the subject matter of any one or more of Examples 84-88 optionally include wherein providing the data segment includes anonymizing the data segment.

In Example 90, the subject matter of Example 89 optionally includes wherein anonymizing the data segment includes assigning an anonymous identity, the connection between the anonymous identity and user identity corresponding to the data segment kept secret from a requester originating the request.

In Example 91, the subject matter of Example 90 optionally includes wherein the anonymous identity is used by a user to query the external store for the external data segments.

In Example 92, the subject matter of any one or more of Examples 84-91 optionally include wherein the operations comprise receiving the results obtained using the data segment from a requester of the request.

In Example 93, the subject matter of Example 92 optionally includes wherein receiving the results includes receiving a second template used to create the results.

In Example 94, the subject matter of any one or more of Examples 67-93 optionally include wherein the operations comprise using the experimental results to find additional users via correlation of the experimental results and other results produced by other users.

In Example 95, the subject matter of any one or more of Examples 67-94 optionally include wherein the operations comprise: requesting an external data segment from an external user; receiving the external data segment in a sandboxed form; and presenting the external data segment in a sandbox, the sandbox preventing re-use or storage of the external data segment.

In Example 96, the subject matter of any one or more of Examples 67-95 optionally include wherein the operations comprise: receiving second experimental results and a corresponding template, the second experimental results composed of data segments from a group of users; providing a user interface to allow a user to inspect the second experimental results; collecting, in response to the user inspecting the second experimental results, an additional data segment from a user that is not in the group of users; executing the corresponding template with the data segments from the group of users or the second experimental results and the additional data segment to create enhanced second experimental results; and presenting, via the user interface, the enhanced second experimental results.

In Example 97, the subject matter of Example 96 optionally includes wherein the data segments for the group of users have a privacy level of at least public or analytic.

In Example 98, the subject matter of any one or more of Examples 96-97 optionally include wherein the additional data segment has a privacy level of private and a recipient of the second experimental results has a predefined relationship with the user that is not in the group of users, the predefined relationship permitting access to private data.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for group data exchange, the system comprising:
a pattern comparator to:
obtain template from a local store, the template defining data segments and operations on data segments;
extract a data segment definition from the template, the data segment definition including a set of demographic values; and
execute a scenario in accordance with the template using a local data segment and external data segments to produce an experimental result; and
a transceiver to:
query an external store for the external data segments with a definition including at least one demographic value from the set of demographic values, the external data segments including an owner entity; and
communicate the experimental result to the owner entity.

2. The system of claim 1, wherein to obtain the template includes the pattern comparator to present a user interface, the user interface including:
a set of data of data streams;
a set of output providers; and
an assembly area where a data stream is connected to an output provider, the combination of the data stream, the connection, and the output provider being a template.

3. The system of claim 1, wherein the data segments are portions of a data stream.

4. The system of claim 3, wherein the portions are determined by a time-value in the data stream distinguishable from other time-values in the data stream.

5. The system of claim 3, wherein a data stream is output of a sensor measuring an aspect of a user.

6. The system of claim 1, comprising security circuitry to:
test, in response to the pattern comparator receiving a request from a second party for a data segment, the request against an anonymity framework; and
provide the data segment when the request complies with the anonymity framework and not-providing the data segment otherwise.

7. The system of claim 1, wherein the transceiver is to use the experimental results to find additional users via correlation of the experimental results and other results produced by other users.

8. The system of claim 1, wherein the pattern comparator is to:
request an external data segment from an external user;
receive the external data segment in a sandboxed form; and
present the external data segment in a sandbox, the sandbox preventing re-use or storage of the external data segment.

9. The system of claim 1, wherein:
the transceiver is to:
receive second experimental results and a corresponding template, the second experimental results composed of data segments from a group of users; and
collect, in response to a user inspecting the second experimental results, an additional data segment from a user that is not in the group of users; and
the pattern comparator is to:
provide a user interface to allow the user to inspect the second experimental results;
execute the corresponding template with the data segments from the group of users or the second experimental results and the additional data segment to create enhanced second experimental results; and
present, via the user interface, the enhanced second experimental results.

10. The system of claim 9, wherein the additional data segment has a permission of private and a recipient of the second experimental results has a predefined relationship with the user that is not in the group of users, the predefined relationship permitting access to private data.

11. A method for group data exchange, the method comprising:
obtain template from local store, the template defining data segments and operations on data segments;
extract a data segment definition from the template, the data segment definition including a set of demographic values;
query an external store for external data segments with a definition including at least one demographic value from the set of demographic values, the external data segments including an owner entity;
execute a scenario in accordance with the template using a local data segment and the external data segments to produce an experimental result; and
communicate the experimental result to the owner entity.

12. The method of claim 11, comprising:
receiving a request from a second party for a data segment;
testing the request against an anonymity framework; and
providing the data segment when the request complies with the anonymity framework and not-providing the data segment otherwise.

13. The method of claim 12, wherein the anonymity framework includes limiting requests to a predetermined number within a predetermined time window.

14. The method of claim 12, wherein the anonymity framework includes a minimum number of participants to a result of which the data segment will be a part.

15. The method of claim 14, wherein the minimum number is greater than three.

16. At least one machine readable medium including instructions for group data exchange, the instructions, when executed by a machine, cause the machine to perform operations comprising:
obtain template from local store, the template defining data segments and operations on data segments;
extract a data segment definition from the template, the data segment definition including a set of demographic values;
query external store for external data segments with a definition including at least one demographic value from the set of demographic values, the data segments including an owner entity;
execute a scenario in accordance with the template using a local data segment and the external data segments to produce an experimental result; and
communicate the experimental result to the owner entity.

17. The at least one machine readable medium of claim 16, wherein to obtain the template includes presenting a user interface, the user interface including:
a set of data of data streams;
a set of output providers; and
an assembly area where a data stream is connected to an output provider, the combination of the data stream, the connection, and the output provider being a template.

18. The at least one machine readable medium of claim 16, wherein the data segments are portions of a data stream.

19. The at least one machine readable medium of claim 18, wherein the portions are determined by a time-value in the data stream distinguishable from other time-values in the data stream.

20. The at least one machine readable medium of claim 18, wherein a data stream is output of a sensor measuring an aspect of a user.

21. The at least one machine readable medium of claim 16, wherein the operations comprise:
receiving a request from a second party for a data segment;
testing the request against an anonymity framework; and
providing the data segment when the request complies with the anonymity framework and not-providing the data segment otherwise.

22. The at least one machine readable medium of claim 16, wherein the operations comprise using the experimental results to find additional users via correlation of the experimental results and other results produced by other users.

23. The at least one machine readable medium of claim 16, wherein the operations comprise:
requesting an external data segment from an external user;
receiving the external data segment in a sandboxed form; and
presenting the external data segment in a sandbox, the sandbox preventing re-use or storage of the external data segment.

24. The at least one machine readable medium of claim 16, wherein the operations comprise:
receiving second experimental results and a corresponding template, the second experimental results composed of data segments from a group of users;
providing a user interface to allow a user to inspect the second experimental results;
collecting, in response to the user inspecting the second experimental results, an additional data segment from a user that is not in the group of users;
executing the corresponding template with the data segments from the group of users or the second experimental results and the additional data segment to create enhanced second experimental results; and
presenting, via the user interface, the enhanced second experimental results.

25. The at least one machine readable medium of claim 24, wherein the additional data segment has a permission of private and a recipient of the second experimental results has a predefined relationship with the user that is not in the group of users, the predefined relationship permitting access to private data.
